(19) United States
(12) Patent Application Publication
(10) Pub. No.: US 2025/0202170 A1
(43) Pub. Date: Jun. 19, 2025

(54) CHARGING INLET

(71) Applicant: Yazaki Corporation, Tokyo (JP)

(72) Inventors: Yusuke AOKI, Shizuoka (JP); Naoto IKEYA, Shizuoka (JP); Takashi TSUKAMOTO, Shizuoka (JP); Hidetaka HONDO, Kanagawa (JP)

(73) Assignee: Yazaki Corporation, Tokyo (JP)

(21) Appl. No.: 18/973,432

(22) Filed: Dec. 9, 2024

(30) Foreign Application Priority Data
Dec. 18, 2023 (JP) 2023-213175

(51) Int. Cl. H01R 13/66; B60L 53/16; H01R 13/405

(52) U.S. Cl. CPC H01R 13/6683; B60L 53/16; H01R 13/405

(57) ABSTRACT

The charging inlet includes a front housing; a terminal stored in the front housing; a thermistor stored in the front housing and detecting the temperature of the terminal; and a terminal holder attached to the front housing and holding the terminal. The terminal holder has a protrusion for regulating slip-off of the thermistor stored in the front housing.

### CROSS-REFERENCE TO RELATED APPLICATIONS

The present application is based on, and claims priority from the prior Japanese Patent Application No. 2023-213175, filed on Dec. 18, 2023, the entire contents of which are incorporated herein by reference.

### TECHNICAL FIELD

The present disclosure relates to a charging inlet.

### BACKGROUND

JP2017-220355 A discloses a technology related to a charging unit. Conventionally, a charging inlet installed in a vehicle has been used to supply (charge) electric power to a battery mounted in a vehicle such as an electric vehicle and a plug-in hybrid vehicle from the outside of the vehicle (for example, see JP2017-220355 A). The charging inlet described in JP2017-220355 A includes an electric wire, a retainer having a cylindrical portion into which an electric wire is inserted, a thermistor stored in the cylindrical portion, and a thermistor holder attached to the retainer and pressing the electric wire toward the thermistor.

### SUMMARY OF THE INVENTION

The work of attaching the thermistor holder to the retainer is required in a manufacturing process of the charging inlet, whereby not only the working time is prolonged, but also the number of parts is increased due to requirement of the thermistor holder that is a part separate from the retainer. As a result, the manufacturing cost of the charging inlet may increase.

The present disclosure has been made in view of such problems of the conventional technology. It is an object of the present disclosure to provide a charging inlet in which the working time is shortened and the number of parts are reduced in the manufacturing process of the charging inlet.

A charging inlet according to an aspect of the present embodiment includes a housing; a terminal stored in the housing; a temperature detecting element stored in the housing and detecting the temperature of the terminal; and a terminal holder attached to the housing and holding the terminal, in which the terminal holder has a regulator for regulating slip-off of the temperature detecting element stored in the housing.

According to the present disclosure, it is possible to provide a charging inlet in which the working time is shortened and the number of parts are reduced in the manufacturing process of the charging inlet.

### BRIEF DESCRIPTION OF DRAWINGS

FIG. 1 is an exploded perspective view illustrating an example of a charging inlet according to a first embodiment.

FIG. 2 is a front view of a charging inlet according to the first embodiment.

FIG. 3 is a sectional view taken along line A-A in FIG. 2.

FIG. 4 is an exploded perspective view illustrating an example of a charging inlet according to a second embodiment.

FIG. 5 is a front view of a charging inlet according to the second embodiment.

FIG. 6 is a sectional view taken along line B-B in FIG. 5.

FIG. 7 is an exploded perspective view illustrating an example of a charging inlet according to a third embodiment.

FIG. 8 is a front view of a charging inlet according to the third embodiment.

FIG. 9 is a sectional view taken along line C-C in FIG. 8.

### DETAILED DESCRIPTION OF THE INVENTION

Hereinafter, a charging inlet according to the present embodiments will be described in detail with reference to the drawings. Note that the dimensional ratio in the drawings is exaggerated for the sake of explanation and may differ from the actual ratio.

### First Embodiment

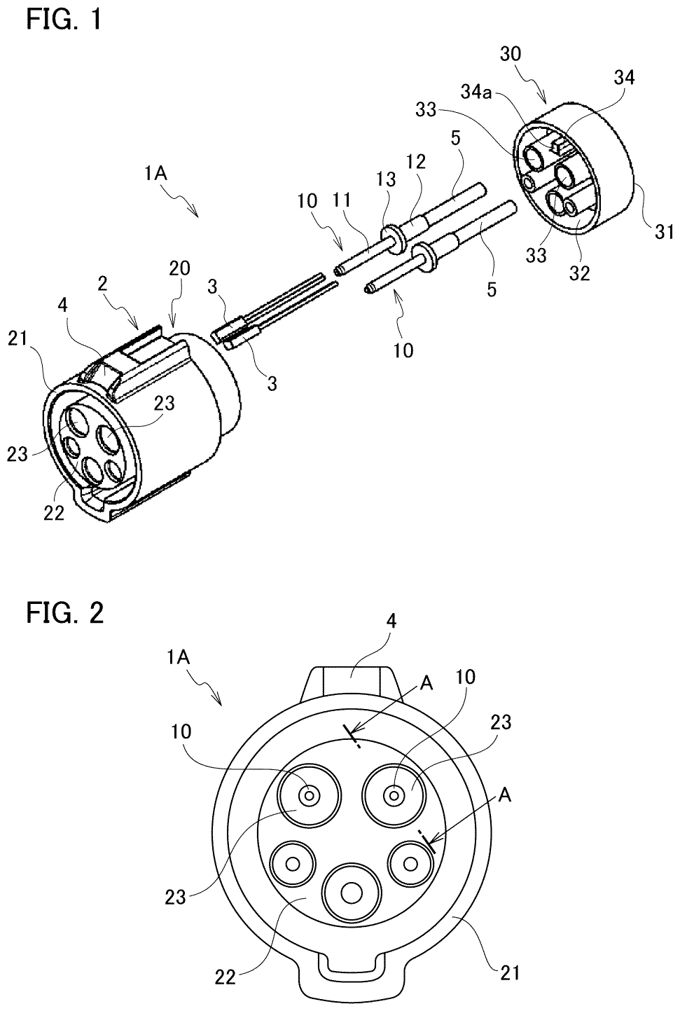

First, a configuration of a charging inlet 1A according to a first embodiment will be described with reference to the drawings. FIGS. 1 to 3 are views illustrating the charging inlet 1A according to the first embodiment.

As illustrated in FIGS. 1 to 3, the charging inlet 1A is formed to be fitted with a charging connector (not illustrated) that is provided with a mating terminal (not illustrated). The charging inlet 1A includes an inlet connector 2 and a rear connector (not illustrated) attached to the inlet connector 2.

The inlet connector 2 has a connector housing 20 in which a plurality of terminals 10 are arranged, and an outer hood 21 covering the circumference of the connector housing 20.

The connector housing 20 has a front housing 22 made of a resin arranged in the outer hood 21, and a terminal holder 30 made of a resin and attached to a rear part (on a rear connector side) of the front housing 22.

The front housing 22 is formed integrally with the outer hood 21. The front housing 22 includes a plurality of terminal storage chambers 23 for storing the plurality of terminals 10, and a temperature detecting element storage part (a thermistor storage part 24) for storing a temperature detecting element (a thermistor 3) described below. On the other hand, the outer hood 21 is provided with a lock 4 for retaining engagement with a mating terminal (not illustrated).

The terminal holder 30 is disposed between the front housing 22 and the rear connector. The terminal holder 30 is provided with a holder body 31 in a shape of a disk, and a holder tube 32 in a cylindrical shape, protruding from the holder body 31 toward the front housing 22. The holder tube 32 is formed integrally with the holder body 31.

The holder body 31 is provided with a plurality of terminal supports 33 for supporting the plurality of terminals 10 on an insertion side of a charging connector (not illustrated). The terminal supports 33 are formed in a cylindrical shape, for example, and the terminals 10 supported by the terminal supports 33 are each formed by a charging terminal, a signal terminal, an earth terminal, or the like. The terminal supports 33 are formed integrally with the holder body 31.

Further, the holder body 31 of the terminal holder 30 is provided with a regulator (a protrusion 34) for regulating slip-off of the temperature detection element (the thermistor 3) stored in the temperature detection element storage part (the thermistor storage part 24) of the front housing 22. The protrusion 34 is formed, for example, in a shape of a square column, and a tip 34a of the protrusion 34 is abutted against a rear end of the terminals 10 stored in the terminal storage chambers 23 of the front housing 22. The protrusion 34 is formed integrally with the holder body 31.

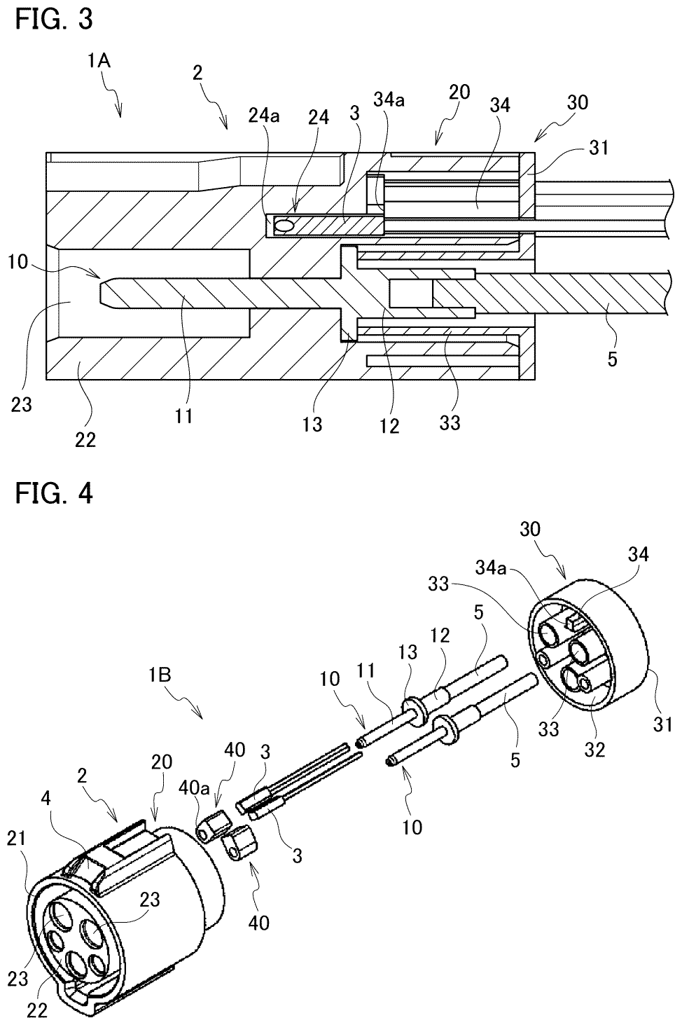

The terminals 10 made of metal (for example, copper) are stored in the terminal storage chambers 23 (see FIG. 3). The terminals 10 have a terminal connector 11 electrically connected to a mating terminal (not illustrated), an electric wire connector 12 electrically connected to an electric wire 5, and a holding portion (a flange 13) which is provided between the terminal connector 11 and the electric wire connector 12, and held by the front housing 22.

The thermistor 3 in which a resistance value changes depending on the temperature is stored in the thermistor storage part 24 (see FIG. 3). The thermistor storage part 24 has a storage hole 24a capable of storing the thermistor 3. The storage hole 24a is formed close to (adjacent to) the terminal storage chambers 23 in which the terminals 10 to be measured are stored. The thermistor 3 is stored in the thermistor storage part 24 (the storage hole 24a), so that the temperature of the terminals 10 can be measured, and transition of the temperature of the terminals 10 can be monitored when the charging inlet 1A is used (when the battery is used).

The temperature detecting element is not particularly limited to the thermistor 3. That is, an element other than the thermistor 3 may be used as the temperature detecting element. In other words, the temperature detecting element may be an element whose output value changes depending on the temperature.

The type (standard) of the charging inlet 1A is not particularly limited, and the present embodiment can be applied to, for example, type 1, type 2, CCS1, and CCS2 charging connectors.

The thermistor 3 is stored in the thermistor storage part 24 (the storage hole 24a) of the front housing 22, so that the thermistor 3 can be arranged at a position close to a heat generating portion at a tip of the terminals 10. Further, the thermistor 3 is stored in the thermistor storage part 24 (the storage hole 24a) of the front housing 22, and is held by the protrusion 34 of the terminal holder 30, so that the position of the thermistor 3 is prevented from shifting. Furthermore, separate parts such as a heat-shrinkable tube and a thermistor holder are not used for fixing (holding) the thermistor 3, so that the working time is shortened and the number of parts is reduced in the manufacturing process of the charging inlet 1A.

As described above, the charging inlet 1A according to the present embodiment includes a housing (the front housing 22) and the terminals 10 stored in the housing (the front housing 22). The charging inlet 1A includes a temperature detection element (the thermistor 3) stored in the housing (the front housing 22) and detecting the temperature of the terminals 10, and a terminal holder 30 attached to the housing (the front housing 22) and holding the terminals 10. The terminal holder 30 includes a regulator (the protrusion 34) for regulating slip-off of the temperature detection element (the thermistor 3) stored in the housing (the front housing 22).

The terminal holder 30 has the protrusion 34, and the thermistor 3 stored in the front housing 22 is held by the protrusion 34 of the terminal holder 30, so that the position of the thermistor 3 is prevented from shifting. Further, separate parts such as a heat-shrinkable tube and a thermistor holder are not used for fixing (holding) the thermistor 3, so that working time is shortened and the number of parts is reduced in the manufacturing process of the charging inlet 1A.

As described above, according to the present embodiment, it is possible to provide the charging inlet 1A in which the working time is shortened and the number of components is reduced in the manufacturing process of the charging inlet 1A.

In the charging inlet 1A, the temperature detecting element may be the thermistor 3.

In comparison with the case that temperature detecting elements other than the thermistor 3 are used, the charging inlet 1A can be manufactured in a small size and at low cost.

In the charging inlet 1A, the terminal holder 30 may have the holder body 31, and the regulator (the protrusion 34) may be formed integrally with the holder body 31.

The protrusion 34 for regulating slip-off of the thermistor 3 is formed integrally with the holder body 31 of the terminal holder 30, and is not a part separate from the terminal holder 30. Separate parts such as a heat shrink tube and a thermistor holder are not used for fixing (holding) the thermistor 3, so that the working time is shortened and the number of parts are reduced in the manufacturing process of the charging inlet 1A.

### Second Embodiment

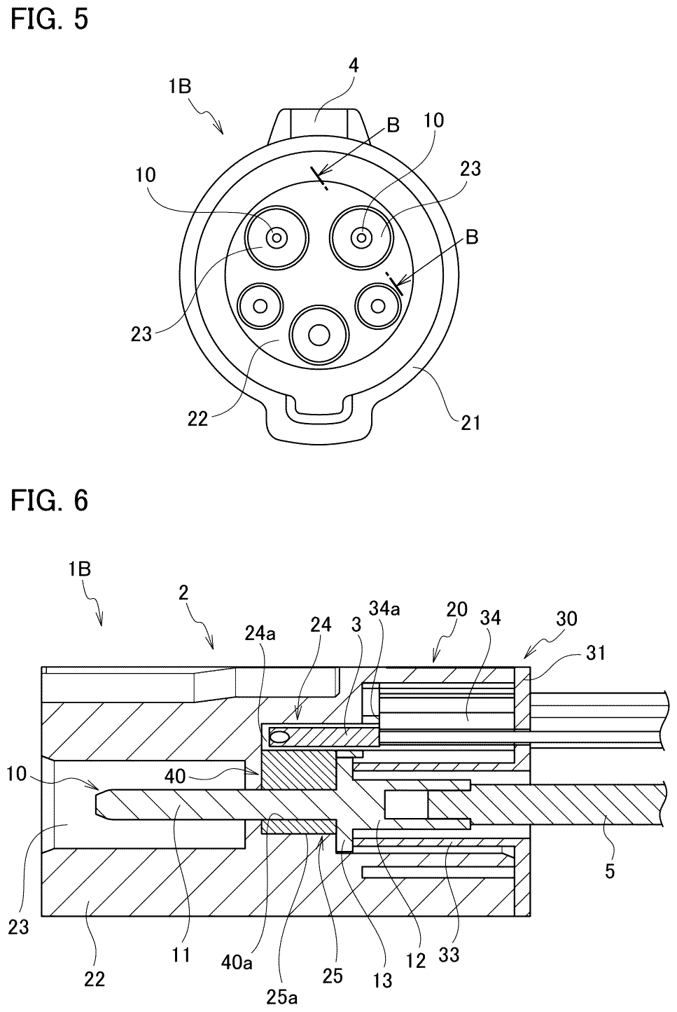

Next, a charging inlet 1B according to a second embodiment will be described with reference to the drawings. FIGS. 4 to 6 are views illustrating the charging inlet 1B according to the second embodiment. The same parts as those of the charging inlet 1A according to the first embodiment will be denoted by the same reference signs, and the different parts will be mainly described.

The front housing 22 has a thermally conductive member storage part (a thermally conductive block storage part 25) for storing a thermally conductive member (a thermally conductive block 40) described below. The thermally conductive block storage part 25 has a block storage hole 25a for storing the thermally conductive block 40. The block storage hole 25a may be connected to the storage hole 24a for storing the thermistor 3, or may be formed separately from the storage hole 24a for storing the thermistor 3.

A thermally conductive block 40 made of metal (for example, aluminum) and having excellent thermal conductivity is stored in the thermally conductive block storage part 25 (the block storage hole 25a) (see FIG. 6). The thermally conductive block 40 has a hole 40a through which the terminal connector 11 of the terminals 10 is inserted. Thus, the heat of the terminals 10 can be easily transmitted to the thermistor 3, and accuracy of temperature detection by the thermistor 3 can be improved.

The thermistor 3 is stored in the thermistor storage part 24 (the storage hole 24a) of the front housing 22, so that the thermistor 3 can be arranged at a position close to a heat generating portion at a tip of the terminals 10. Further, the thermistor 3 is in contact with the terminals 10 through the thermally conductive block 40 made of metal and having excellent thermal conductivity, so that the heat of the terminals 10 can be easily transmitted to the thermistor 3, and accuracy of the temperature detection by the thermistor 3 can be improved. The thermistor 3 is stored in the thermistor storage part 24 (the storage hole 24a) of the front housing 22, and is held by the protrusion 34 of the terminal holder 30, so that the position of the thermistor 3 is prevented from shifting. Furthermore, separate parts such as a heat shrink tube and a thermistor holder are not used for fixing (holding) the thermistor 3, so that the working time is shortened and the number of parts are reduced in the manufacturing process of the charging inlet 1B.

As described above, the charging inlet 1B according to the present embodiment includes a housing (the front housing 22) and the terminals 10 stored in the housing (the front housing 22). The charging inlet 1B includes a temperature detection element (the thermistor 3) stored in the housing (the front housing 22) and detecting the temperature of the terminals 10, and the terminal holder 30 attached to the housing (the front housing 22) and holding the terminals 10. The terminal holder 30 includes a regulator (the protrusion 34) for regulating slip-off of the temperature detection element (the thermistor 3) stored in the housing (the front housing 22).

The terminal holder 30 has the protrusion 34, and the thermistor 3 stored in the front housing 22 is held by the protrusion 34 of the terminal holder 30, so that the position of the thermistor 3 is prevented from shifting. Further, separate parts such as a heat-shrinkable tube and a thermistor holder are not used for fixing (holding) the thermistor 3, so that the working time is shortened and the number of parts is reduced in the manufacturing process of the charging inlet 1B.

As described above, according to the present embodiment, it is possible to provide the charging inlet 1B in which the working time is shortened and the number of parts is reduced in the manufacturing process of the charging inlet 1B.

The charging inlet 1B may include a thermally conductive member (the thermally conductive block 40) stored in the housing (the front housing 22) and having the hole 40a through which each of the terminals 10 is inserted.

The thermistor 3 is in contact with the terminals 10 via the thermally conductive block 40, so that the heat of the terminals 10 is easily transmitted to the thermistor 3, and accuracy of the temperature detection by the thermistor 3 is improved.

### Third Embodiment

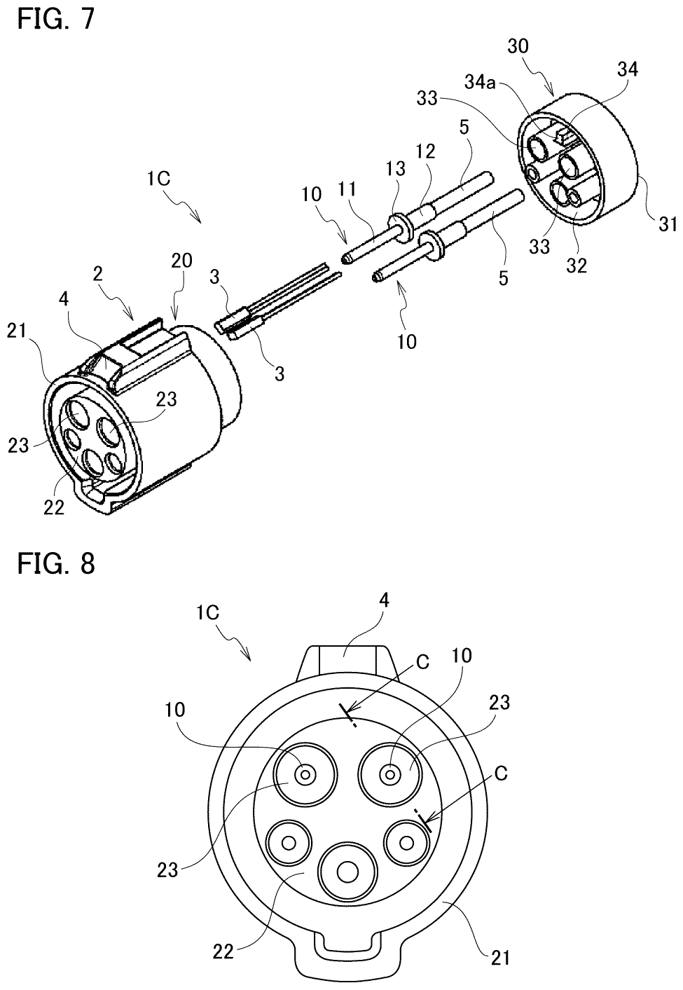

Next, a charging inlet 1C according to a third embodiment will be described with reference to the drawings. FIGS. 7 to 9 are views illustrating the charging inlet 1C according to the third embodiment. The same parts as those of the charging inlet 1B according to the second embodiment will be denoted by the same reference numerals, and the different parts will be mainly described.

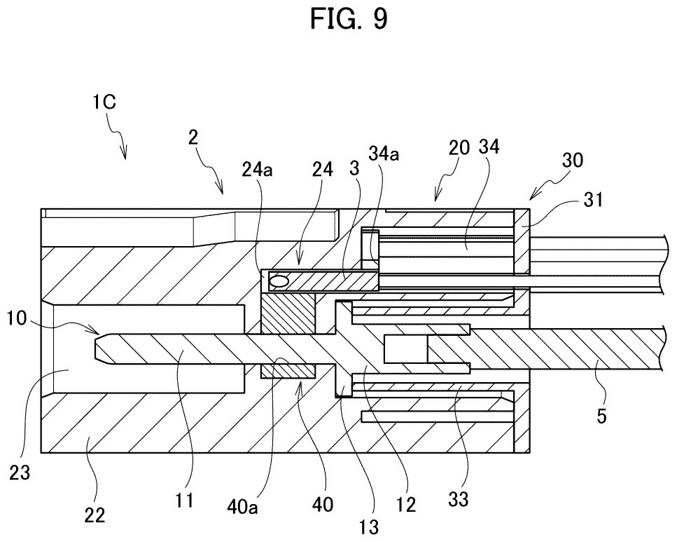

The thermally conductive block 40 made of metal (for example, aluminum) and having excellent thermal conductivity is insert-molded in advance into the front housing 22 (see FIG. 9). The thermally conductive block 40 has the hole 40a through which the terminal connector 11 of the terminals 10 is inserted. Thus, the heat of the terminals 10 can be easily transmitted to the thermistor 3, and accuracy of the temperature detection by the thermistor 3 can be improved.

The thermistor 3 is stored in the thermistor storage part 24 (the storage hole 24a) of the front housing 22, so that the thermistor 3 can be arranged at a position close to a heating portion at a tip of the terminals 10. Further, the thermistor 3 is in contact with the terminals 10 through a thermally conductive block 40 made of metal and having excellent thermal conductivity, so that the heat of the terminals 10 can be easily transmitted to the thermistor 3, and accuracy of the temperature detection by the thermistor 3 can be improved. The thermistor 3 is stored in the thermistor storage part 24 (the storage hole 24a) of the front housing 22, and is held by the protrusion 34 of the terminal holder 30, so that the position of the thermistor 3 can be prevented from shifting. Furthermore, separate parts such as a heat shrink tube and a thermistor holder are not used for fixing (holding) the thermistor 3, so that the working time is shortened and the number of parts can be reduced in the manufacturing process of the charging inlet 1C.

As described above, the charging inlet 1C according to the present embodiment includes a housing (the front housing 22) and the terminals 10 stored in the housing (the front housing 22). The charging inlet 1C includes a temperature detection element (the thermistor 3) stored in the housing (the front housing 22) and detecting the temperature of the terminals 10, and the terminal holder 30 attached to the housing (the front housing 22) and holding the terminals 10. The terminal holder 30 includes a regulator (the protrusion 34) for regulating slip-off of the temperature detection element (the thermistor 3) stored in the housing (the front housing 22).

The terminal holder 30 has the protrusion 34, and the thermistor 3 stored in the front housing 22 is held by the protrusion 34 of the terminal holder 30, so that the thermistor 3 is prevented from shifting. Further, separate parts such as a heat-shrinkable tube and a thermistor holder are not used for fixing (holding) the thermistor 3, so that the working time is shortened and the number of parts is reduced in the manufacturing process of the charging inlet 1C.

As described above, according to the present embodiment, it is possible to provide the charging inlet 1C in which the working time is shortened and the number of parts is reduced in the manufacturing process of the charging inlet 1C.

In the charging inlet 1C, the thermally conductive member (the thermally conductive block 40) may be insert-molded into the housing (the front housing 22).

The thermally conductive block 40 is insert-molded into the front housing 22 in advance, and is not a part separate from the front housing 22. Therefore, the working time is shortened, and the number of parts is reduced in the manufacturing process of the charging inlet 1C.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A charging inlet comprising:
a housing;
a terminal stored in the housing;
a temperature detection element stored in the housing and detecting the temperature of the terminal; and
a terminal holder attached to the housing and holding the terminal,
wherein the terminal holder has a regulator for regulating slip-off of the temperature detecting element stored in the housing.

2. The charging inlet according to claim 1, comprising a thermally conductive member stored in the housing and having a hole through which the terminal is inserted.

3. The charging inlet according to claim 2, wherein the thermally conductive member is insert-molded into the housing.

4. The charging inlet according to claim 1, wherein the temperature detecting element is a thermistor.

5. The charging inlet according to claim 1, wherein
the terminal holder has a holder body; and
the regulator is integrally formed with the holder body.
